(19) United States
(12) Patent Application Publication
(10) Pub. No.: US 2014/0042819 A1
(43) Pub. Date: Feb. 13, 2014

(54) ELECTRONIC APPARATUS AND POWER MANAGEMENT METHOD

(71) Applicant: BriView Corporation, Taoyuan (TW)

(72) Inventor: Cheng-Hung YU, Taoyuan (TW)

(73) Assignee: BriView Corporation, Taoyuan (TW)

(21) Appl. No.: 13/892,379

(22) Filed: May 13, 2013

(30) Foreign Application Priority Data
Aug. 9, 2012 (TW) 101128793

(51) Int. Cl. H02J 9/00

(52) U.S. Cl. CPC H02J 9/005
USPC 307/80

(57) ABSTRACT

The disclosure discloses an electronic apparatus and a power management method are disclosed. The electronic apparatus includes a power board, a remote-controller receiving board and a mainboard. The power board is configured for converting public electricity into a standby voltage and a main power voltage. The remote-controller receiving board, coupled with the power board, is configured to be operated with the standby voltage. When the remote-controller receiving board receives a control signal from a remote controller, the remote-controller receiving board sends a power-switching signal to the power board. The power board starts or stops supplying the main power voltage according to the power-switching signal. The mainboard, coupled with the power board, is configured to be operated with the main power voltage.

### RELATED APPLICATIONS

This application claims priority to Taiwan Application Serial Number 101128793, filed Aug. 9, 2012, which is herein incorporated by reference.

### BACKGROUND

1. Technical Field

The present disclosure relates to an electronic devices and a power to management method thereof. More particularly, the present disclosure relates to an electronic device capable of reducing its standby power consumption and a power management method thereof.

2. Description of Related Art

Environmental issues are highly concerned in the modern society. Appliances or electronic equipments are requested to reduce energy consumption. The energy-saving appliances are regarded as the mainstream of appliances. In general applications, the appliances are connected to the public electricity outlet for long. Even not being activated, the appliances stay in a standby mode. For example, when the television is turned off, the television is not disconnected from the power source but operates under the standby mode instead. When it receives the activation signal from a remote controller, the television will be turned on and operates to display. In other words, conventional appliances still cause a certain degree of standby power consumption even when the appliances are turned off.

Reference is made to FIG. 1, which is a functional block diagram illustrating a conventional electronic apparatus 100. The conventional apparatus 100 includes a power board 120, a mainboard 140 and a remote-controller receiving board 160. The power board 120 is connected to the external source of public electricity 110 (e.g., the public electricity outlet) for performing some processes (e.g., surge limitation, filtering, EMI reduction, rectification, voltage transforming, power factor adjustment, impedance matching, etc) on the external power signal from the public electricity 110. Afterward, the power board 120 converted the processed power signal into proper specifications required by the mainboard 140 (e.g., the processed power signal can be converted into 5V, 12V and 24V main power voltages required by the mainboard 140). When the electronic apparatus 100 is not activated, the mainboard 140 in the standby mode may utilize a lower mainboard standby voltage (e.g., 5V) to maintain basic functions, and the mainboard standby voltage is also used to drive the remote-controller receiving board 160, which is configured to detect an activation signal generated by a remote controller according to user manipulations. The activation signal is used for remotely turning on the electronic apparatus 100.

In prior arts, before the external power signal from the public electricity 110 being supplied to the remote-controller receiving board 160, the external power signal is modulated by the power board 120 at first and then transmitted via the mainboard 140 to the remote-controller receiving board 160. However, the power board 120 may have components including a surge limitation circuit, a filtering circuit, an EMI reduction circuit, a rectification circuit, a voltage transforming circuit, a power factor adjustment circuit and/or an impedance matching circuit. In addition, the mainboard 140 also contains some peripheral circuits. Therefore, the standby voltage required by the mainboard 140 is usually at a level higher than a minimum operating voltage required by the remote-controller receiving board 160. As a result, the electronic apparatus 100 will waste unnecessary power and have high energy consumption in the standby mode, and it is against the goal of energy-saving.

### SUMMARY

An aspect of the disclosure is to provide an electronic apparatus, which includes a power board, a remote-controller receiving board and a mainboard. The power board is configured for converting public electricity into a standby voltage and a main power voltage. The remote-controller receiving board, coupled with the power board, is configured to be operated with the standby voltage. The remote-controller receiving board sends a power-switching signal to the power board when the remote-controller receiving board receives a control signal from a remote controller, such that the power board starts or stops providing the main power voltage according to the power-switching signal. The mainboard, coupled with the power board, is configured to be operated with the main power voltage.

Another aspect of the disclosure is to provide a power management method suitable for an electronic apparatus, which includes a power board, a remote-controller receiving board and a mainboard. The power board is coupled to public electricity. The power management method includes steps of: converting the public electricity into a standby voltage and supplying the remote-controller receiving board with the standby voltage; generating a power-switching signal to the power board when the remote-controller receiving board receives a control signal; and, selectively converting the public electricity into a main power voltage and supplying the mainboard with the main power voltage according to the power-switching signal, or terminating the supplement of the main power voltage according to the power-switching signal.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference to the accompanying drawings as follows:

FIG. 1 is a functional block diagram illustrating a conventional electronic apparatus;

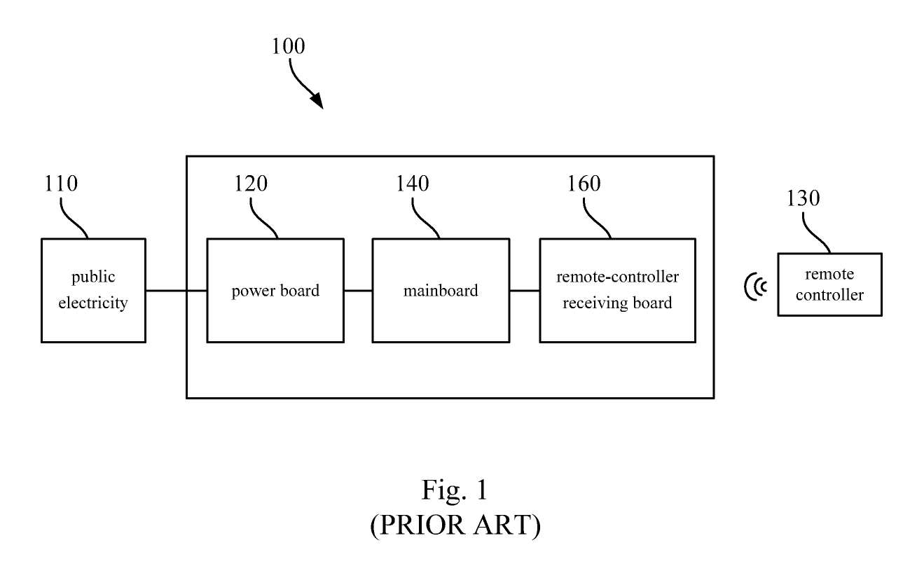

FIG. 2 is a schematic diagram illustrating an electronic apparatus according to an embodiment of the disclosure;

FIG. 3 is a functional block diagram illustrating the electronic apparatus in FIG. 2;

FIG. 4 is a flow diagram illustrating a power management method according to an embodiment of the disclosure; and

FIG. 5 is a flow diagram illustrating two operational examples according the power management method shown in FIG. 4.

### DESCRIPTION OF THE EMBODIMENTS

In the following description, several specific details are presented to provide a thorough understanding of the embodiments of the present disclosure. One skilled in the relevant art will recognize, however, that the present disclosure can be practiced without one or more of the specific details, or in combination with or with other components, etc. In other instances, well-known implementations or operations are not shown or described in detail to avoid obscuring aspects of various embodiments of the present disclosure.

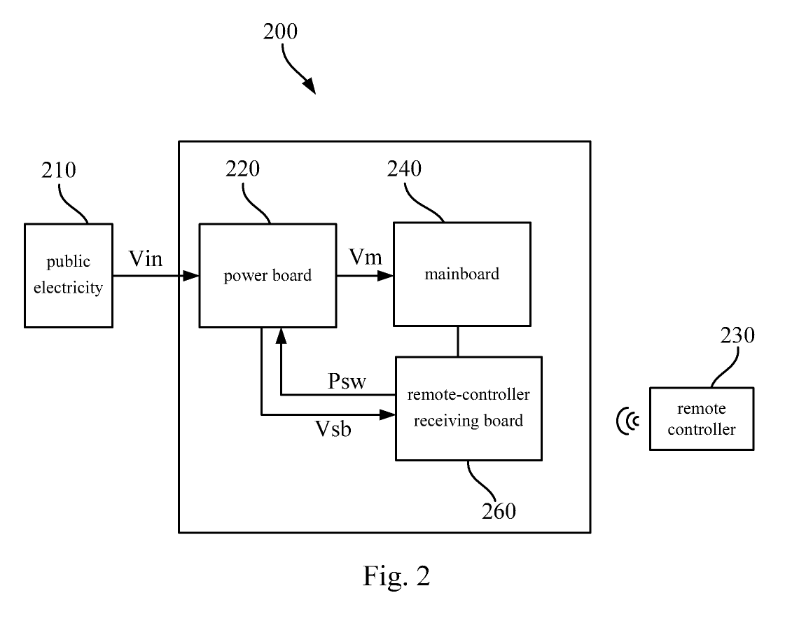

Reference is made to FIG. 2, which is a schematic diagram illustrating an to electronic apparatus 200 according to an embodiment of the disclosure. The electronic apparatus 200 includes a power board 220, a mainboard 240 and a remote-controller receiving board 260. The power board 220 is configured for converting a public electricity input signal Vin of public electricity 210 into a standby voltage Vsb and a main power voltage Vm. The remote-controller receiving board 260, coupled with the power board 220, is configured to be operated with the standby voltage Vsb. In practical applications, the electronic apparatus 200 can be a television, a displayer, a household appliance or any equivalent electronic device which can be switched on/off remotely.

When the remote-controller receiving board 260 receives a control signal from a remote controller 230, the remote-controller receiving board 260 sends a power-switching signal Psw to the power board 220, such that the power board 220 starts or stops providing the main power voltage Vm (converted from the public electricity input signal Vin of public electricity 210) according to the power-switching signal Psw.

The mainboard 240, coupled with the power board 220, is configured to be operated with the main power voltage Vm. In other words, when a user manipulate the remote controller 230 to transmit a control signal representing “remote activation instruction” such that the remote-controller receiving board 260 correspondingly sends the power-switching signal Psw representing “activation instruction” to the power board 220, the power board 220 starts supplying the main power voltage Vm to the mainboard 240, so as to drive the mainboard 240 to operate under a normal mode.

On the other hand, when a user manipulate the remote controller 230 to transmit a control signal representing “remote power-off instruction” such that the remote-controller receiving board 260 correspondingly sends the power-switching signal Psw representing “power-off instruction” to the power board 220, the power board 220 stops supplying the main power voltage Vm to the mainboard 240. In this case, the electronic apparatus 200 operates under the standby mode. In the standby mode, the power board 220 generates the standby voltage Vsb and provides the standby voltage Vsb directly to remote-controller receiving board 260. It must be added that, the minimum operation voltage required by the remote-controller receiving board 260 (i.e., the standby voltage Vsb in this embodiment) is generally at a lower level than a minimum operation voltage required by the mainboard 240 (e.g., the mainboard standby voltage in prior art). Therefore, the embodiment of this disclosure may save energy and achieve the lower standby power consumption by providing the standby voltage Vsb directly to the remote-controller receiving board 260 while entering the standby mode. Therefore, the embodiment is better in energy-saving in comparison to the conventional application, which provides the standby voltage to the remote-controller receiving board through the mainboard. There is an example in the following paragraphs for demonstrating how to achieve aforesaid functions of the electronic device 200.

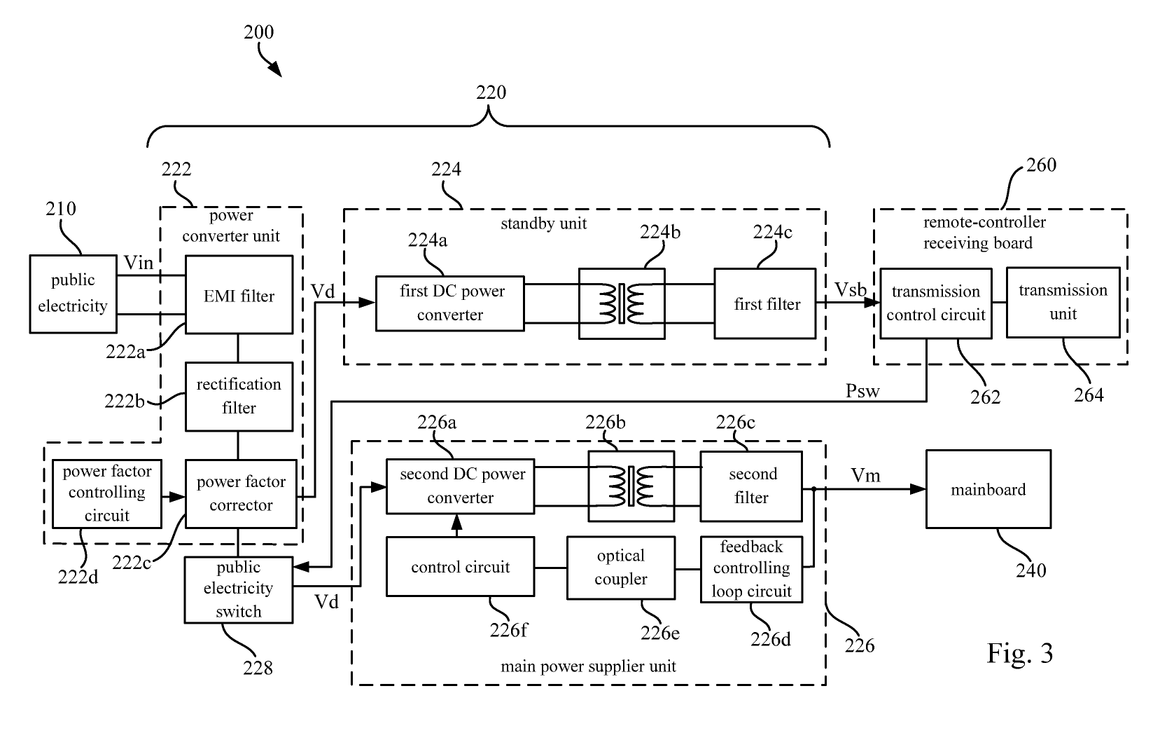

Reference is made to FIG. 3, which is a functional block diagram illustrating the electronic apparatus 200 in FIG. 2. As shown in FIG. 3, the power board 220 of the electronic apparatus 200 includes a power converter unit 220, a standby unit 224, a main power supplier unit 226 and a public electricity switch 228. The power converter unit 222 is coupled with the public electricity 210. The standby unit 224 is coupled between the power converter unit 222 and the remote-controller receiving board 260. The main power supplier unit 226 is coupled between the power converter unit 222 and the mainboard 240. The public electricity switch 228 is further coupled between the power converter unit 222 and the main power supplier unit 226.

The power converter unit 222 is configured for converting the public electricity 210 into a direct-current (DC) voltage Vd. As the embodiment shown in FIG. 3, the power converter unit 222 includes an Electromagnetic Interference (EMI) filter 222a, a rectification filter 222b, a power factor corrector 222c and a power factor controlling circuit 222d.

The EMI filter 222a is configured for receiving the public electricity input signal Vin of the public electricity 210, and the EMI filter 222a is used to filter out the Electromagnetic Interference existed on the public electricity input signal Vin, and also used to suppress the inrush waveform on the public electricity input signal Vin, such that the EMI filter 222a may generate a filtered voltage. The rectification filter 222b is configured for receiving the filtered voltage, performing a rectification process on the filtered voltage, and generating a rectified voltage. The power factor corrector 222c is configured for receiving the rectified voltage. The power factor controlling circuit 222d is configured for controlling the power factor corrector 222c, and accordingly the power factor corrector 222c corrects the rectified voltage and outputs the DC voltage Vd. The DC voltage Vd generated by the power converter unit 222 is transmitted to the standby unit 224. On the other hand, the DC voltage Vd is selectively transmitted through the public electricity switch 228 to the main power supplier unit 226.

The standby unit 224 is configured for converting the DC voltage Vd into the standby voltage Vsb. As shown in FIG. 3, the standby unit 224 may include a first DC power converter 224a, a first transformer 224b and a first filter 224c. The first DC power converter 224a is connected to a primary side of the first transformer 224b. The first DC power converter 224a is configured for receiving the DC voltage Vd, converting the DC voltage Vd (e.g., converting into a resonant waveform or an alternating current signal), and sending the converted outcome to the primary side of the first transformer 224b. The first filter 224c is connected to a secondary side of the first transformer 224b. The first filter 224c is used for filtering the induced voltage on the secondary side of the first transformer 224b and outputting the standby voltage Vsb. The standby voltage Vsb is transmitted to the remote-controller receiving board 260, for supplying the remote-controller receiving board 260 with required electricity during the standby mode.

In general, a voltage level of the standby voltage required by the remote-controller receiving board 260 is relative low. In practice, the voltage level of the standby voltage can be about 3V. In an embodiment, the first DC power converter 224a can be a flyback DC power converter. The flyback DC power converter is suitable to be operated at a low voltage level.

In this example, the remote-controller receiving board 260 may include a transmission control circuit 262 and a transmission unit 264. The transmission unit 264 can be used for receiving a control signal sent from the remote controller 230. For example, contents of the control signal may include some instructions such as activation, shutdown, channel-switching, volume-adjusting, and brightness-adjusting. The control signal in the disclosure is limited to include a specific instruction. When, the instructional contents of the control signal is related to activation or shutdown, the transmission control circuit 262 of the remote-controller receiving board 260 sends the power-switching signal Psw representing the instruction of “activation” or “shutdown” to the public electricity switch 228 of the power board 220, such that the public electricity switch 228 is switched on or switched off, and accordingly the power board 220 starts or stops supplying the mainboard 240 with the main power voltage Vm.

If the user manipulate the remote controller 230 to send the control signal representing the instruction of “remote activation” and the remote-controller receiving board 260 sends the corresponding power-switching signal Psw representing the instruction of “activation” to the power board 220, the public electricity switch 228 is turned on (i.e., conducted) for transmitting the DC voltage Vd to the main power supplier unit 226 in this case. On the other hand, if the user manipulate the remote controller 230 to send the control signal representing the instruction of “remote shutdown” and the remote-controller receiving board 260 sends the corresponding power-switching signal Psw representing the instruction of “shutdown” to the power board 220, the public electricity switch 228 is turned off (i.e., not conducted), such that the DC voltage Vd is not transmitted to the main power supplier unit 226 in this case.

The main power supplier unit 226 is configured for converting the DV voltage Vd into the main power voltage Vm when the public electricity switch 228 is turned on. The main power voltage Vm is used for driving the mainboard 240 and further to complete the activation process.

As shown in FIG. 3, the main power supplier unit 226 includes a second DC power converter 226a, a second transformer 226b and a second filter 226c. The second DC power converter 226a is connected to a primary side of the second transformer 226b. The second DC power converter 226a is configured for receiving the DC voltage Vd, converting the DC voltage Vd (e.g., converting into a resonant waveform or an alternating current signal), and sending the converted outcome to the primary side of the second transformer 226b. The second filter 226c is connected to a secondary side of the second transformer 226b. The second filter 224c is used for filtering the induced voltage on the secondary side of the second transformer 226b and outputting the main power voltage Vm for driving the mainboard 240. In practices, the main power voltage Vm required by the mainboard 240 may include voltage signals with different power specifications, e.g., the main power voltage Vm may include voltage signals with 5V/1 A, 12V/4 A, 24V/2 A, etc.

In an embodiment, the second DC power converter 226a can be an inductor-inductor-capacitance (LLC) resonant power converter. The LLC resonant power converter is suitable for a wide operational voltage range.

To be added that, the voltage level of the main power voltage Vm required by the mainboard 240 is normally higher than the voltage level of the minimum operational voltage of the remote-controller receiving board 260 (i.e., the standby voltage Vsb in the embodiment), and the voltage level of the standby voltage Vsb required by the remote-controller receiving board 260 is lower than the voltage level of the mainboard standby voltage in a conventional device. Under the shutdown mode or standby mode, the power board 220 in the embodiment only generates the standby voltage Vsb required by the remote-controller receiving board 260 without generating the main power voltage Vm, such that the standby power consumption can be reduced.

In addition, the main power supplier unit 226 shown in FIG. 3 further includes a feedback controlling loop circuit 226d, an optical coupler 226e and a control circuit 226f. The feedback controlling loop circuit is configured for providing a feedback signal according to a state of the main power voltage Vm. The optical coupler 226e is connected between the feedback controlling loop circuit 226d and the control circuit 226f. The optical coupler 226e transmits signals via an optical transmitting channel (non-electrically connection), such that the optical coupler 226e can be an electrical isolator between the primary/secondary sides in the power system. The control circuit 226f is connected with the optical coupler 226e for controlling the second DC power converter 226a according to the feedback signal, in order to stabilize the output of the main power voltage Vm.

In aforesaid embodiment, the power board of the electronic apparatus includes the public electricity switch. When the public electricity switch is turned off (the electronic apparatus is remotely turned off or in a standby mode), the power board stop supplying the main power voltage. In addition, a standby voltage generated by the power board is directly transmitted to the remote-controller receiving board without passing through the mainboard. Therefore, the unnecessary power consumption on the power board and the mainboard can be avoided, so as to reduce the standby voltage and achieve the energy-saving goal.

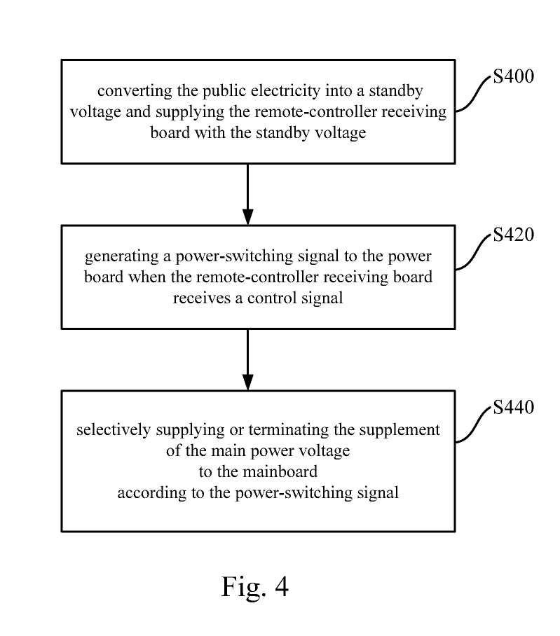

Reference is made to FIG. 4, which is a flow diagram illustrating a power management method according to an embodiment of the disclosure. The power management method can, and not limited to, be used on the electronic apparatus 200 in aforesaid embodiment, or on any equivalent electronic devices.

As shown in FIG. 4, the power management method in the embodiment execute step S400 at first for converting the public electricity into a standby voltage and supplying the remote-controller receiving board with the standby voltage.

Referring to FIG. 3 at the same time, during step S400, the public electricity input signal Vin of public electricity 210 can be converted into the DC voltage Vd by the power converter unit 222 of the power board 220, and then the standby unit 224 convert the DC voltage Vd into the standby voltage Vsb and supply the remote-controller receiving board 260 with the standby voltage Vsb. The details can be referred to aforesaid embodiments and not to be repeated here.

Afterward, step S420 is executed for generating a power-switching signal to the power board when the remote-controller receiving board receives a control signal. The contents of the control signal may include some instructions such as activation, shutdown, channel-switching, volume-adjusting, and brightness-adjusting. The embodiment mainly focuses on the instructions of “activation” and “shutdown”, and step S420 is executed to generate the corresponding power-switching signal to the power board.

Afterward, step S440 is executed for selectively converting the public electricity into a main power voltage and supplying the mainboard with the main power voltage according to the power-switching signal, or terminating the supplement of the main power voltage according to the power-switching signal.

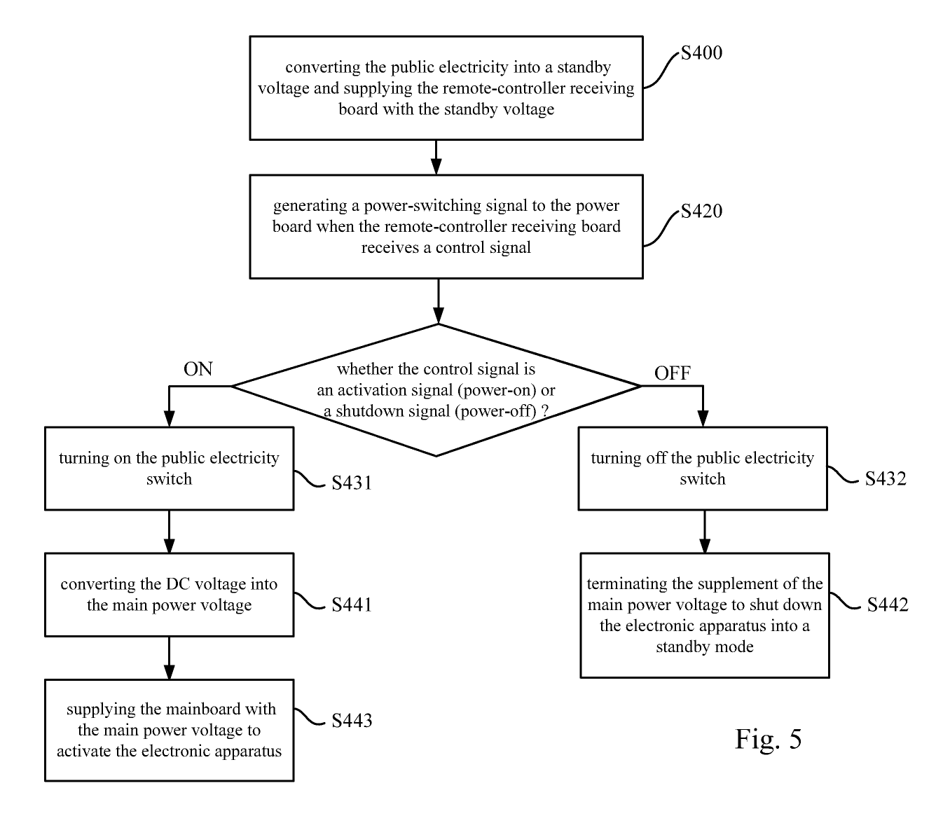

Two operational examples in the following paragraphs are utilized to demonstrate steps in aforesaid power management method. Reference is made to FIG. 5, which is a flow diagram illustrating two operational examples to according the power management method shown in FIG. 4.

The first operational example demonstrates that the control signal received in step S420 from a remote controller is an activation signal (related to a power-on instruction). In this case, step S431 is executed for turning on the public electricity switch according to the power-switching signal. Referring the embodiment shown in FIG. 3, the public electricity switch 228 transmits the DC voltage Vd to the main power supplier unit 226. Afterward, step S441 is executed for converting the DC voltage Vd into the main power voltage Vm. Afterward, step S443 is executed for supplying the mainboard with the main power voltage Vm, so as to activate the electronic apparatus.

On the other hand, the second operational example demonstrates that the control signal received in step S420 from a remote controller is a shutdown signal (related to a power-off instruction). The power management method further execute step S432 for turning off the public electricity switch according to the power-switching signal. Afterward, step S442 is executed for terminating the supplement of the main power voltage, so as to shut down the electronic apparatus into a standby mode. To be added that, after the providing of the main power voltage is stopped, residual electricity remaining on the mainboard is utilized to complete shutdown operations.

Based on aforesaid embodiments, the disclosure provides an electronic apparatus and a power management method thereof. A power board of the electronic apparatus includes a public electricity switch. When the public electricity switch is turned off (the electronic apparatus is remotely turned off or in a standby mode), the power board stop supplying the main power voltage. In addition, a standby voltage generated by the power board is directly to transmitted to the remote-controller receiving board without passing through the mainboard. Therefore, the unnecessary power consumption on the power board and the mainboard can be avoided, so as to reduce the standby voltage and achieve the energy-saving goal.

As is understood by a person skilled in the art, the foregoing embodiments of the present disclosure are illustrative of the present disclosure rather than limiting of the present disclosure. It is intended to cover various modifications and similar arrangements included within the spirit and scope of the appended claims, the scope of which should be accorded with the broadest interpretation so as to encompass all such modifications and similar structures.

What is claimed is:

1. An electronic apparatus, comprising:
a power board, configured for converting public electricity into a standby voltage and a main power voltage;
a remote-controller receiving board, coupled with the power board and configured to be operated with the standby voltage, wherein the remote-controller receiving board sends a power-switching signal to the power board when the remote-controller receiving board receives a control signal from a remote controller, such that the power board starts or stops providing the main power voltage according to the power-switching signal; and
a mainboard, coupled with the power board and configured to be operated with the main power voltage.

2. The electronic apparatus as claimed in claim 1, wherein the power board comprises:
a power converter unit configured for converting the public electricity into a direct-current (DC) voltage;
a standby unit configured for converting the DC voltage into the standby voltage;
a public electricity switch configured to be switched according to the power-switching signal; and
a main power supplier unit configured for converting the DC voltage into the main power voltage when the public electricity switch is switched on.

3. The electronic apparatus as claimed in claim 2, wherein the main power supplier unit stops providing the main power voltage when the public electricity switch is switched off according to the power-switching signal.

4. The electronic apparatus as claimed in claim 3, wherein the power converter unit comprises:
an Electromagnetic Interference (EMI) filter configured for receiving the public electricity and generating a filtered voltage;
a rectification filter configured for receiving the filtered voltage and generating a rectified voltage;
a power factor corrector configured for receiving the rectified voltage; and
a power factor controlling circuit configured for controlling the power factor corrector, accordingly the power factor corrector corrects the rectified voltage and outputs the DC voltage.

5. The electronic apparatus as claimed in claim 3, wherein the standby unit comprises:
a first transformer;
a first DC power converter connected to a primary side of the first transformer, the first DC power converter being configured for receiving the DC voltage; and
a first filter connected to a secondary side of the first transformer for outputting the standby voltage.

6. The electronic apparatus as claimed in claim 5, wherein the first DC power converter is a flyback DC power converter.

7. The electronic apparatus as claimed in claim 5, wherein the main power supplier unit comprises:
a second transformer;
a second DC power converter connected to a primary side of the second transformer for receiving the DC voltage; and
a second filter connected to a secondary side of the second transformer for outputting the main power voltage.

8. The electronic apparatus as claimed in claim 7, wherein the second DC power converter is an inductor-inductor-capacitance (LLC) resonant power converter.

9. The electronic apparatus as claimed in claim 7, wherein the main power supplier unit further comprises:
a feedback controlling loop circuit configured for providing a feedback signal according to a state of the main power voltage;
an optical coupler connected with the feedback controlling loop circuit; and
a control circuit connected with the optical coupler for controlling the second DC power converter according to the feedback signal.

10. A power management method, suitable for an electronic apparatus comprising a power board, a remote-controller receiving board and a mainboard, the power board being coupled to public electricity, the power management method comprising:
converting the public electricity into a standby voltage and supplying the remote-controller receiving board with the standby voltage;
generating a power-switching signal to the power board when the remote-controller receiving board receives a control signal; and
selectively converting the public electricity into a main power voltage and supplying the mainboard with the main power voltage according to the power-switching signal, or terminating the supplement of the main power voltage according to the power-switching signal.

11. The power management method as claimed in claim 10, further comprising:
converting the public electricity into a direct current (DC) voltage; and
converting the DC voltage into the standby voltage for supplying the remote-controller receiving board with the standby voltage.

12. The power management method as claimed in claim 11, wherein the power board comprises a public electricity switch which is switchable by the power-switching signal, when the control signal is an activation signal from a remote controller, the power management method further comprises:
turning on the public electricity switch according to the power-switching signal;
converting the DC voltage into the main power voltage; and
supplying the mainboard with the main power voltage, so as to activate the electronic apparatus.

13. The power management method as claimed in claim 11, wherein the power board comprises a public electricity switch which is switchable by the power-switching signal, when the control signal is a shutdown signal from a remote controller, the power management method further comprises:
turning off the public electricity switch according to the power-switching to signal; and
terminating the supplement of the main power voltage, so as to shut down the electronic apparatus into a standby mode.

14. The power management method as claimed in claim 13, wherein residual electricity remaining on the mainboard is utilized to complete shutdown operations after the providing of the main power voltage is stopped.
